(19) United States
(12) Patent Application Publication
(10) Pub. No.: US 2025/0099972 A1
(43) Pub. Date: Mar. 27, 2025

(54) CARBON PURIFICATION USING MECHANICAL AGITATION

(71) Applicant: CZERO, INC., Goleta, CA (US)

(72) Inventors: Samuel SHANER, Goleta, CA (US); Brett PARKINSON, Goleta, CA (US); Andrew CALDWELL, Goleta, CA (US); Ryan PATRICK, Goleta, CA (US); Lucas RUSH, Goleta, CA (US)

(21) Appl. No.: 18/832,612

(22) PCT Filed: Jan. 25, 2023
(86) PCT No.: PCT/US2023/061283

§ 371 Date: Jul. 24, 2024

Related U.S. Application Data
(60) Provisional application No. 63/302,846, filed on Jan. 25, 2022.

(51) Int. Cl. B02C 23/08; B01J 6/00; C01B 32/05

(52) U.S. Cl. CPC B02C 23/08; B01J 6/008; C01B 32/05

(57) ABSTRACT

A process for purifying a solid that has a contaminant adhered to a surface of the solid includes passing the solid through a mechanical agitator, agitating the solid comprising the contaminant adhered to the surface of the solid in the mechanical agitator, removing at least a portion of the contaminant from the surface of the solid based on the agitating to form a purified solid, and removing the purified solid from the mechanical agitator.

### CROSS-REFERENCE TO RELATED APPLICATIONS

This application claims priority to U.S. Provisional Application No. 63/302,846 filed on Jan. 25, 2023 and entitled, “CARBON PURIFICATION USING MECHANICAL AGITATION,” which is incorporated herein by reference in its entirety.

### STATEMENT REGARDING GOVERNMENTALLY SPONSORED RESEARCH OR DEVELOPMENT

None.

### BACKGROUND

In a variety of chemical processes, multiphase mixtures of different chemicals and materials coexist in vessels, and it is desirable to separate the different phases. Two-phase separations are ubiquitous in chemical processing and wastewater treatment and many methods are deployed commercially.

### SUMMARY

The present invention relates to methods for treating mixtures of gases, liquids, and solids.

In some embodiments, a process for purifying a solid comprising a contaminant adhered to a surface of the solid comprises passing the solid through a mechanical agitator; agitating the solid comprising the contaminant adhered to the surface of the solid in the mechanical agitator; removing at least a portion of the contaminant from the surface of the solid based on the agitating to form a purified solid; and removing the purified solid from the mechanical agitator.

In some embodiments, a process for producing and purifying carbon comprising a contaminant adhered to a surface of the carbon comprises contacting a hydrocarbon gas with a molten metal in a pyrolysis reactor; forming the carbon in response to the contacting, wherein the carbon comprises the contaminant adhered to the surface of the carbon; passing the carbon through a mechanical agitator; agitating the carbon comprising the contaminant adhered to the surface of the carbon in the mechanical agitator; removing at least a portion of the contaminant from the surface of the carbon based on the agitating to form a purified carbon; and removing the purified carbon from the mechanical agitator.

In some embodiments, a reactor system comprises: a pyrolysis reactor configured to receive a hydrocarbon gas and generate carbon as a product; the carbon, wherein the carbon comprises a contaminant adhered to a surface of the carbon; a mechanical agitator configured to receive the carbon comprising the contaminant and remove at least a portion of the contaminant from the surface of the carbon to generate a purified carbon; and the portion of the contaminant removed from the surface of the carbon.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIGS. 1A and 1B schematically illustrate the process aspects of the inventions described.

FIG. 2 schematically illustrates the formation of liquid droplets from gas bubbles breaking the surface of a liquid.

FIG. 3 schematically illustrates a bubble column with gas bubbles rising in liquid containing suspended solids with disengagement and separation in cyclone.

FIG. 4 schematically illustrates separation strategy for solids with dispersed contaminants.

FIG. 5 schematically illustrates a milling operation to separate solids from dispersed condensed phase contaminants.

FIG. 6 schematically illustrates a milling operation to separate solids from dispersed liquid phase contaminants.

FIG. 7 schematically illustrates a milling operation to separate solids from dispersed condensed phase contaminants suspended in a liquid.

FIG. 8 schematically illustrates a vertical stirred ball mill operation to separate solids from dispersed condensed phase contaminants.

FIG. 9 schematically illustrates use of a jet milling operation to separate solids from dispersed condensed phase contaminants.

### DETAILED DESCRIPTION

The following definitions are used herein:

Reactant: Any substance that enters into and is potentially altered in the course of a chemical transformation.

Product: A substance resulting from a set of conditions in a chemical or physical transformation.

Reactor: A container or apparatus in which substances are made to undergo chemical transformations.

Catalyst: A substance that increases the rate of a chemical reaction or enables a chemical reaction to proceed under different conditions than otherwise possible.

Condensed Phase: A liquid and/or solid.

Bubble column: A vertically-arranged, liquid-filled vessel with gas inserted at the bottom.

Film: A thin covering or coating.

The present disclosure describes methods and devices for separation of solid and gas phase products from three-phase mixtures of liquids, solids, and gases, and the removal of contaminants from the solids once removed from such systems. A major challenge of such separations is to efficiently remove large flowrates of the gases and solids traveling through a liquid containing vessel without entraining or discharging any of the liquid media. In systems discharging a gas-solid suspension, it is often unavoidable to entrain liquid as droplets and/or aerosols that are formed at the liquid surface during disengagement resulting in liquid media loss. Solids discharged in separate streams may have residual liquid media adhered to the solid surface in the exiting predominately solid stream; the predominately gas stream may also contain liquid droplets as an aerosol and/or vapor. Some methods and devices addressing the removal of liquid droplets from gas streams or solid particles from gas streams include demisters, cyclones, and filters, though less is known regarding approaches for selective removal and retention of liquids from vessels containing liquids, gasses, and solids. The present disclosure provides methods and devices for disengaging multi-phase mixtures of gases and solids from liquids and producing either streams containing a solid-gas suspension without retained liquid, or, streams containing predominately solids and predominately gases with particular applicability to high temperature liquids including molten salts and/or molten metals.

There are presently no commercial systems for the separation of high temperature mixtures of solids, gases, and liquids from liquid containing vessels whereby the liquid media is retained in the vessel while the gas and solid phase components are continuously removed. The methods and devices disclosed herein make possible the separation of high temperature three-phase mixtures where gases and solids are in contact with high temperature liquids in a vessel and it is desirable to remove the gas and solid phase components while retaining the liquid phase within the vessel. The disclosed systems and methods make the separate production of gaseous products and solid products from three-phase mixtures in liquid filled vessels possible where the phases are intermixed while the liquid phase is retained in the vessel. Further, some aspects allow for the further removal from the solid stream, adventitious solids from the desirable product stream. This element of the disclosed systems and methods is particularly novel and unique for the application of removing solid or liquid metals from solid carbon.

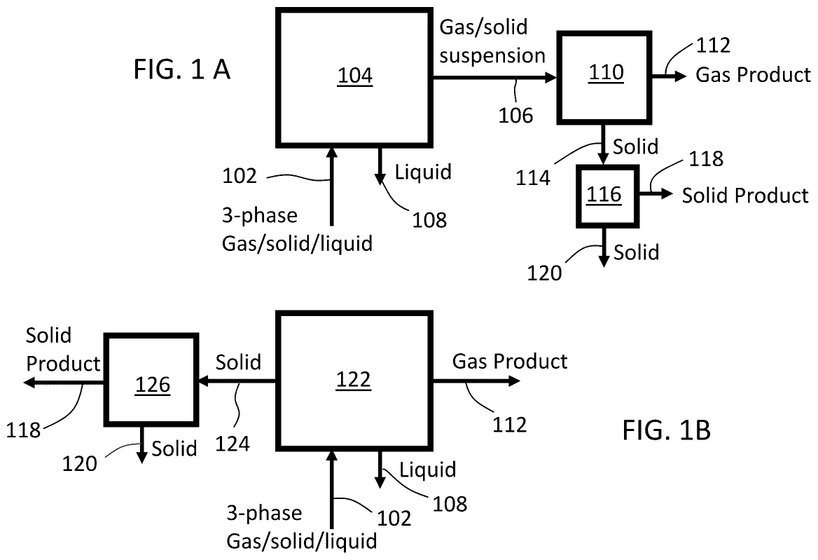

As disclosed herein, the multi-phase separations can be achieved using methods and devices using one of two distinct philosophical approaches for achieving the separations described for a broad range of materials with different phase interactions. Reference is made to FIG. 1. In FIG. 1A, a three-phase mixture 102 enters a separation sub-system 104 whereby the mixture 102 of liquid-gas-solid is separated into a gas stream 106 with the solid phase material contained in suspension with the liquid 108 remaining and whereby subsequent gas-solid separation 110 is used to ultimately produce gas product 112 and solid product 114 streams. Within the separation sub-system 104 methods and devices are used to ensure the liquid phase is retained. The solid product 114 can be further treated in a separation system 116 to further separate components of the solid product 114 into a solid product stream 118 and a second solids stream 120.

In FIG. 1B, the three-phase mixture 102 enters a separation sub-system 122 whereby the mixture 102 is caused to separate into a gas product stream 112 containing predominately the gas-phase components and a separate stream 124 containing predominately the solid-phase components. The liquid 108 can be separated and/or remain within the system. The separate stream 124 can be further treated in a separation system 126 to further separate components of the separate stream 124 into a solid product stream 118 and a second solids stream 120. In some aspects, the solids separation system 116 in FIG. 1A can be the same or similar to the solids separation system 126 in FIG. 1B. From methods and devices implementing one or the other approach streams of solids can be produced and other systems and methods can be used to process the solid stream into a purer solid product stream removing any retained condensed phase contaminants.

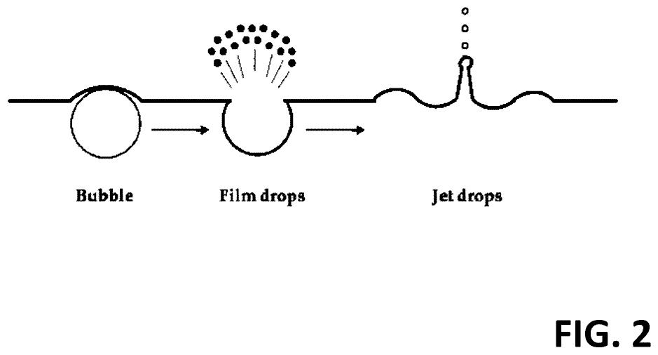

When gas-solid removal is performed in a solid-liquid suspension and the solid particles are entrained within the gas stream, additional entrainment of the liquid as droplets or aerosols is almost inevitable. Specific aspects of the methods and systems disclosed herein are directed at reducing the liquid content of the gas solid suspension. For illustration, reference is made to FIG. 2 which depicts gas bubbles breaking at a liquid surface and producing droplets of the liquid in the gas phase. Depending on the gas flow rate and properties of the liquid and droplets, the liquid may be entrained with the gas. It is desirable to reduce or minimize the amount of liquid released from the surface and leaving the vessel with the gas and solid phase materials. For the purposes of this disclosure all liquid present in the gas stream will be referred to as droplets regardless of the size of the liquid particles. of the release and entrainment of the droplets can be controlled using an integrated approach of: 1) minimizing the quantity of liquid in the entrained droplets, and/or 2) selective removal of the liquid droplets from the gas-solid stream. The approach consists of several elements: 1) decreased droplet formation by, i) liquid surface stabilization and dampening with novel liquid wettable materials, ii) bubble diversion and redirection, and iii) forced coalescence of the bubbles, and, 2) entrained droplet removal by i) cyclonic flow generation, ii) forced liquid impingement and retention, and iii) centripetal extraction, and/or 3) enhanced solids conveyance through the selection of the conditions to produce a desired solids particle size (e.g., enhanced carbon conveyance by melt selection that promotes the production of finer carbon particle size distributions).

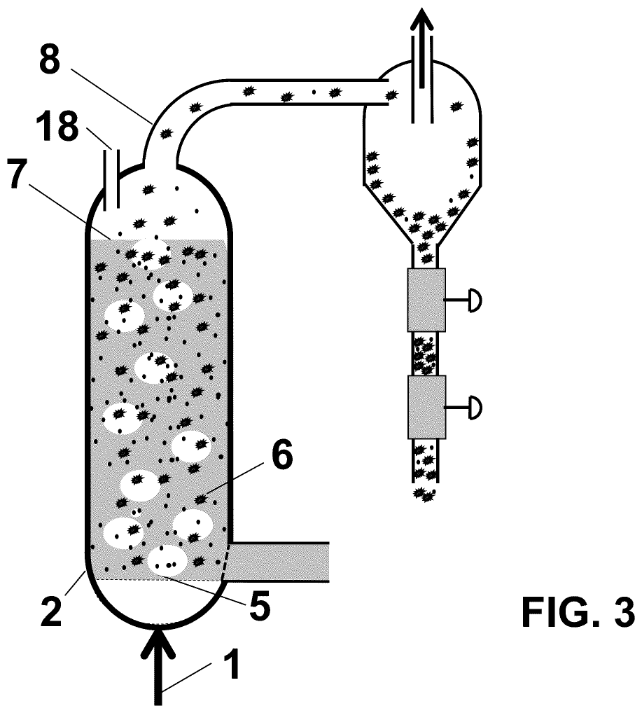

In some aspects such as shown in FIG. 3, a gas stream 1 may be introduced as bubbles 5 into a liquid filled vessel 2 which may be a reactor (e.g., a bubble column reactor as shown in FIG. 3). Solids 6 may be introduced into, present, and/or formed in the vessel 2. Similar multiphase environments may exist without bubbles such as in liquid trickle beds, falling films, or fluidized bed reactors. In several applications, solids may be present or formed in the liquid such that their relative densities or the action of the bubbles rising to the liquid surface can transport the solids to the liquid surface 7, or another region of the vessel where the products can be removed. In FIG. 3, disengagement of the gas and solid from the liquid occurs at the top of the vessel 2, and the gas flowrate can be controlled such that the solid particulates are suspended in the gas flow field and exit the vessel 2 through an outlet 8 where a separator 11 such as a cyclone can be used to both separate the solids and gas stream and remove by the centripetal flow field any liquid droplets that may have been co-suspended by contacting the liquid droplets with the cyclone wall.

The vessel and configuration shown in FIG. 3 can comprise any suitable three phase system having gas, liquid, and solids present, and need not comprise a reactor vessel. In some aspects, the vessel can comprise a reactor having a gas, liquid, and solid phase present. For purposes of illustration only, the vessel 2 shown in FIG. 3 can comprise a reactor such as a high temperature reactor comprising a liquid such as a molten media (e.g., a molten metal and/or molten salt).

In some aspects, a high temperature reactor can comprise a hydrocarbon pyrolysis reactor. In a pyrolysis reactor, hydrocarbon materials such as natural gas or other molecules or mixtures of molecules containing predominately hydrogen and carbon atoms are transformed into a solid carbon product that can be readily handled and prevented from forming carbon oxides in the atmosphere, as well as a gas phase co-product (e.g., hydrogen, unreacted hydrocarbons, other pyrolysis products, etc.). In some embodiments, the gas-phase co-product, hydrogen, can be used as a fuel or chemical. During methane pyrolysis, carbon is stoichiometrically produced at three times the rate of hydrogen by mass. The overall process in this case can be referred to as pyrolysis, CₙH₂ₘ→mH₂+nC.

A challenge with hydrocarbon pyrolysis in molten media systems is the separation of the carbon from the molten media and the removal of residual media from the carbon once the carbon is removed from the reactor. The carbon produced can have a significant amount of residual media in the carbon product. For example, more than 50 wt. % of the solid product can comprise residual media (e.g., a metal from a molten metal, a salt from a molten salt, etc.) in the carbon as the material is initially removed. Various mechanical techniques can be used to remove a portion of the residual media, but this may not be sufficient to reduce the residual amount of media to an acceptable level. Various considerations such as the cost of replacing the media and the ability to use contaminated carbon may affect the viability of the pyrolysis process. As a result, any additional techniques or processes for removing or reducing the amount of residual media to an acceptable level would be useful in the pyrolysis process. For this reason, carbon cleanliness becomes a high priority for any process that implements expensive media or catalysts that may leave the reactor with the solid carbon during a gas-solid separation step—resulting in high media recovery and makeup costs.

In a pyrolysis process, the feed gas (e.g., a hydrocarbon gas) can comprise natural gas (e.g., primarily methane), pure methane, or other hydrocarbon containing compositions containing primarily hydrogen and carbon such as heavier hydrocarbon gases (e.g., ethane, propane, etc.), biomass, hydrocarbon liquids, and the like. In some instances, the hydrocarbon gas can contain elements other than hydrogen and carbon (e.g., oxygen, nitrogen, sulfur, etc.), so long as the other elements are only present in minor amounts.

The molten media can comprise a molten salt, a molten metal, or any combination thereof. In some embodiments, the salts can be any salt having a suitable melting point to allow the molten salt or molten salt mixture to be formed within the reactor. In some embodiments, the salt mixture comprises one or more oxidized atoms (M)^{+m} and corresponding reduced atoms (X)⁻¹, wherein M is at least one of K, Na, Mg, Ca, Mn, Zn, La, Al, or Li, and where X is at least one of F, Cl, Br, I, OH, SO₃, or NO₃. Exemplary salts can include, but are not limited to, NaCl, NaBr, KCl, KBr, LiCl, LiBr, CaCl₂, MgCl₂, CaBr₂, AlCl₃, MgBr₂, and combinations thereof. In some embodiments, the liquid can be or contain a molten metal such as nickel, bismuth, copper, platinum, indium, lead, gallium, iron, palladium, tin, cobalt, tellurium, ruthenium, antimony, gallium, magnesium, calcium, sodium, potassium, oxides thereof, or any combination thereof. For example, combinations of metals having catalytic activity for hydrocarbon pyrolysis can include, but are not limited to: nickel-bismuth, copper-bismuth, platinum-bismuth, nickel-indium, copper-indium, copper-lead, nickel-gallium, copper-gallium, iron-gallium, palladium-gallium, platinum-tin, cobalt-tin, nickel-tellurium, copper-tellurium, combinations thereof, and/or alloys thereof.

Combinations of molten metals and molten salts can also be used. Proper selection of materials can result in two phases being present within the molten media, where the two phases can stratify in some instances. For example, a molten salt can be used with a molten metal as provided herein such that the molten salt can float as a liquid layer on top of the molten metal.

When used as a pyrolysis reactor, the reactor vessel 2 can operate at suitable conditions for pyrolysis to occur. In some embodiments, the temperature can be selected to maintain the molten media in the molten state such that the molten media is above the melting point of the composition while being below the boiling point. In some embodiments, the reactor can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C. The reactor can operate at any suitable pressure. The reactor may operate at a pressure between about 1 atm and about 25 atm. Higher pressures are possible with an appropriate selection of the reactor configuration, operating conditions, and flow schemes, where the pressure can be selected to maintain a gas phase within the reactor. The resulting reaction can produce carbon as a solid product that can be retained in the liquid phase molten media and be subject to separation along with any unreacted feed gases and product gases using any of the systems described herein.

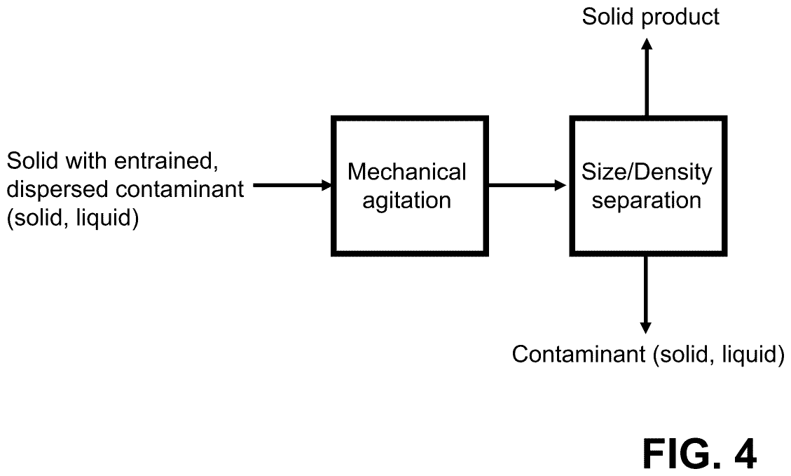

The use of a system as described herein can give rise to a solid product stream that may have unwanted impurities either in the solid or liquid phase. For example, some amount of the liquid may remain adhered or embedded within the solids phase, and the liquid phase may solidify once removed from the vessel to form a solid-solid phase product. As an example, with pyrolysis systems, the molten liquid phase (e.g., a molten metal and/or molten salt) can be adhered to the solid carbon product. The systems and methods disclosed herein provide for further processing of the solids stream by application of mechanical agitation and force, bringing the impurity phase into physical contact with itself to promote aggregation. The aggregation of solid-phase impurities occurs by mechanical joining of the disparate particles and relies on the ductility of the impurity phase, which may be high due to the intrinsic properties of the impurity and can be enhanced with increasing temperature, up to the melting temperature. The aggregation of impurities that, at the temperature of operation, are in the liquid phase occurs by these disparate droplets being brought into physical contact with one another and relies on the high surface tension of the impurity phase to keep itself agglomerated during agitation. Broadly, then, this processing may be defined by two steps as shown in FIG. 4. In the first step, a solids stream with a dispersed contaminant phase, either solid or liquid, can be mechanically agitated with sufficient kinetic energy to induce agglomeration of the contaminant particles. The transfer of kinetic energy to the contaminant particles can be achieved with secondary media or can be done autogenously. The mechanical agitation step results in an increase in the average particle size of the contaminant phase as well as a macroscopic phase separation between the contaminant and the solid product, which can result in a solid phase comprising the contaminant phase and a solid phase comprising the solid product with a reduced amount of contaminant. These attributes, as well as other differences in the physical or chemical properties of the contaminant and solid product phases, may be leveraged in the second step to affect a separation of the contaminant and solid product phases and include, but are not limited to: particle size distribution, mass density, phase transformation temperatures, electronic conductivity, and ferromagnetism.

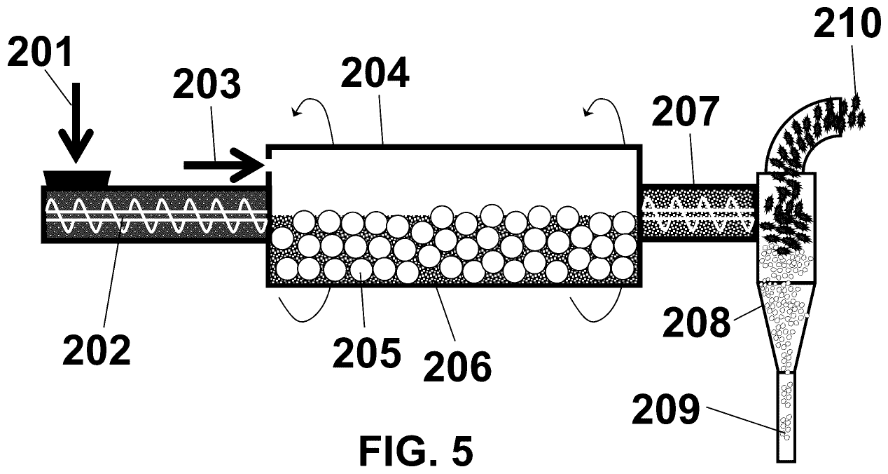

FIG. 5 shows an embodiment as applied to the grinding of solid carbon contaminated with a solid-phase contaminant such as a metal. The contaminated solids stream 201 can be conveyed to a ball mill 204 (e.g. a rotary ball mill) containing the grinding media 205 using a conveyance mechanism 202. While any suitable conveyance mechanism can be used such as a conveyor belt, pneumatic means, or auger, a screw-auger 202 is shown in FIG. 5 as an example only.

The grinding media 205 can comprise any suitable material for mechanically agitating and moving the contaminated solids stream 201. In some examples, the grinding media 205 can comprise metallic or ceramic balls, which can be shaped as spheres, ellipsoids, rods, or the like. The size of the grinding media may depend on the material being processed. In some aspects, the grinding media 205 can have an average diameter of between about 0.1 to about 6 inches.

Upon rotation of the ball mill 204, the contaminated solids stream 201 and the grinding media can be rotated to cause the grinding media 205 to move within the ball mill 204 due to gravity. Macroscopic segregation of the two phases can occur in the particle bed 206 of the ball mill in response to the movement of the grinding media. In some embodiments, the gas environment of the grinding chamber can be kept inert by flowing an inert gas through the ball mill 204, for example through a gas inlet 203. Any suitable inert gas can be used such as nitrogen.

A second conveyance device 207 can direct the milled products to a separator such as an air-classifier 208, cyclone, or the like, which can separate the stream into a carbon-rich product stream 210 and a metal-contaminant-rich stream 209. The second conveyance device 207 can be the same or similar to the conveyance device 202. The air-classifier 208 can separate the lighter phase 210 (e.g., the product phase with a reduced contaminant content) through an air outlet while the heavier phase (e.g., the conglomerated contaminant solid phase) through a lower outlet 209.

Similar milling apparatuses may be used that do not require spherical grinding media, such as rod-mills and hammer-mills and variations thereof, nor require the use of uniaxial rotation, i.e., “roller” configurations, such as planetary mills. Conveyance of the solids stream may be done pneumatically as well as mechanically. The milling may be done in continuously, semi-continuously, or batch. When a semi-continuous or batch configuration is used, a plurality of milling devices can be used to process the solid carbon.

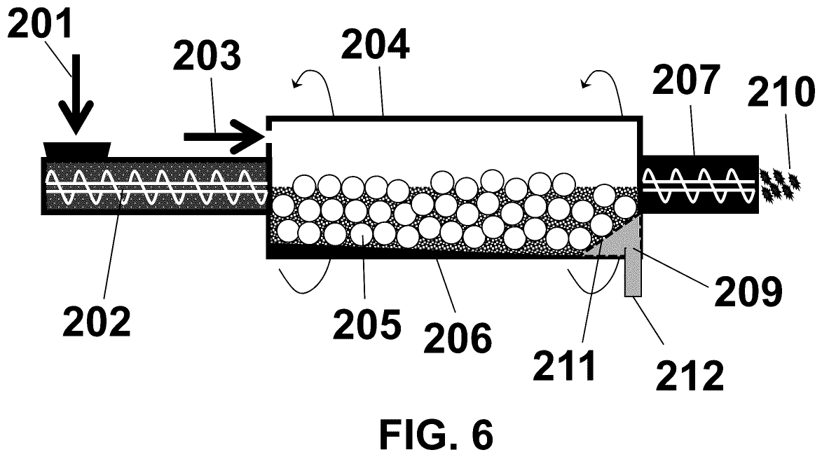

FIG. 6 shows another embodiment as applied to the grinding of solid carbon contaminated with a liquid-phase, metal contaminant. The embodiment of FIG. 5 is similar to the embodiment of FIG. 6, and similar components can be the same or similar, where the same or similar components may not be described again in the interest of brevity. The contaminated solids stream 201 can be conveyed by a conveyor 202 to a ball mill 204 containing the grinding media 205. The conveyor and grinding media can comprise any of the conveyors described with respect to FIG. 5. A screen separator 211 comprising a screen placed at an offset distance within the ball mill 204 interior surface can be used to allow at least a portion of the contaminant to pass through while retaining the solid product within the interior of the screen separator 211. In some aspects, the conveyor surfaces, the grinding media surfaces, the interior surface of the ball mill 204 and/or the surfaces of the screen separator 211 may be non-wetting to the liquid phase of the contaminant. The selection of the materials may depend on the composition and properties of the contaminant at the conditions used to maintain the contaminant in a liquid phase in the ball mill 204.

Macroscopic segregation of the two phases can occurs in the particle bed 206 of the ball mill 204. In some aspects, the conditions within the ball mill 204 can be maintained to retain the contaminant in the liquid phase. For example, one or more heaters or heat sources can be used to maintain the temperature at a level at or above the melting point of the contaminant. The liquid-phase contaminant 209 may be non-wetting to the solid product and to the grinding surfaces, and as a result, the liquid-phase contaminant can pass through the screen separator 211 and collect at the base of the grinding apparatus 212 from where it may be drawn out by tapping, siphoning, etc. In some embodiments, the gas environment of the grinding chamber can be kept inert by flowing an inert gas such as nitrogen gas 203 through the grinding chamber. A second conveyor 207 such as a screw-auger can conveys the milled solid product 210 out of the grinding apparatus. Similar apparatuses for particle agitation may be used that do not require grinding media, such as static mixers and pin mixers. The milling may be done in continuously, semi-continuously, or batch.

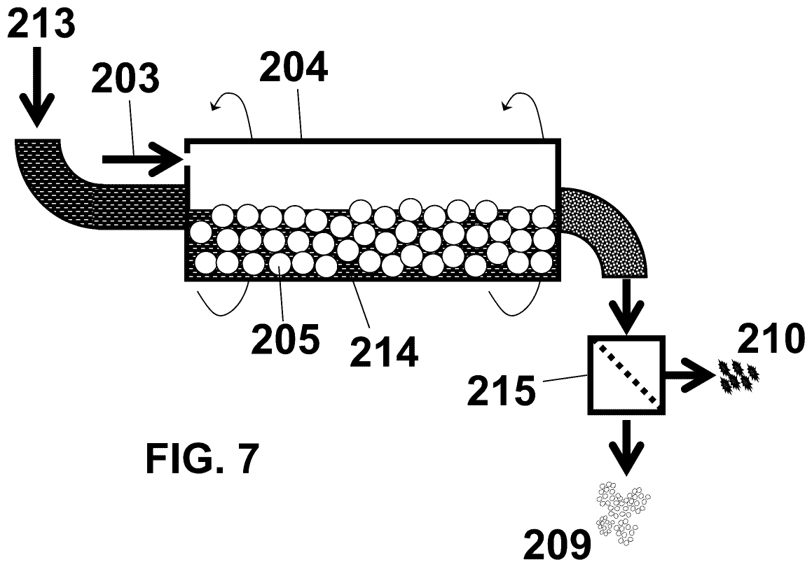

FIG. 7 shows another embodiment as applied to the grinding of solid carbon contaminated with a solid-phase, metal contaminant. Portions of the system shown in FIG. 6 can be the same as or similar to those shown in FIGS. 4 and 5, and the like components will not be described again in detail in the interest of brevity. As illustrated, the contaminated solids can be suspended in a non-reactive liquid to create a slurry 213. The slurry can be gravity-fed into a ball mill 204 containing the grinding media 205. The use of a slurry may simplify the conveyance of the contaminated solids into the ball mill 204. The liquid can comprise any non-reactive liquid that is non-reactive to the solid carbon and the metal contaminant. Examples can include organic liquids, aqueous liquids, and any combinations thereof.

Macroscopic segregation of the metal-contaminant and carbon phases can occur in the slurry 214 within the ball mill. In some embodiments, the gas environment of the grinding chamber can be kept inert by flowing an inert gas such as nitrogen gas through a gas inlet 203. The slurry can be conveyed out of the ball mill and over a filtration apparatus 215 to carry out separation of the larger metal particles 209 from the suspended carbon 210. Alternatively, or in addition, some degree of settling may be done prior to filtration to aid in the separation. Similar milling apparatuses may be used that do not require spherical grinding media, such as rod-mills and hammer-mills and variations thereof, nor require the use of uniaxial rotation, i.e., “roller” configurations, such as planetary mills. The milling may be done in continuously, semi-continuously, or batch.

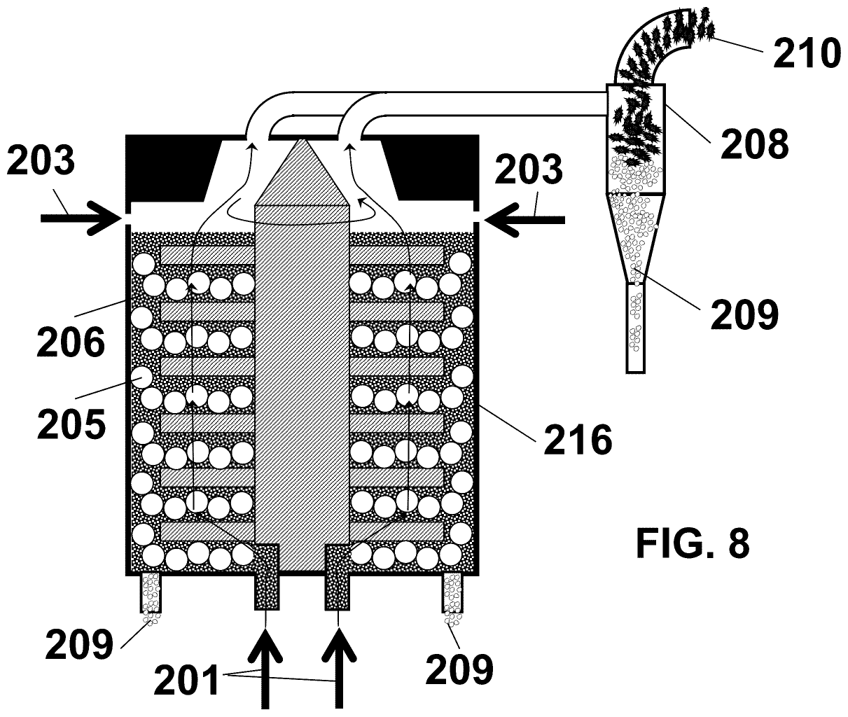

FIG. 8 shows an embodiment of the invention as applied to the grinding of solid carbon contaminated with a solid-phase, metal contaminant. Portions of the system shown in FIG. 8 can be the same as or similar to those shown in FIGS. 4-7, and the like components will not be described again in detail in the interest of brevity. The contaminated solids stream 201 can be conveyed into the base of a vertical stirred ball mill 216 containing the grinding media 205. Depending on the orientation of the ball mill 216, the conveyance mechanism may comprise pneumatic conveyance in order to move the contaminated solid phase into the ball mill 216. The vertical stirred ball mill 216 can comprise a central auger with grinding balls 205 (which can comprise any of the grinding materials described herein) and media. The auger can lift the mixture of the contaminated solid phase and the grinding material as the auger rotates, thereby mechanically agitating the contaminated solid with the grinding material. The grinding material, conglomerated metal contaminant, and some amount of the solid carbon can flow between the auger and the inner walls of the ball mill 216 to return to the base to circulate the materials within the vertical stirred ball mill 216.

Macroscopic segregation of the two phases can occur in the particle bed 206 of the ball mill as the ball mill operates. The agitation of the solid materials using the grinding media can cause the solid phase contaminants to agglomerate to form larger solid contaminant particles. The solid carbon having a lower concentration of the solid contaminant can flow to the top of the ball miller for removal at the top of the ball mill. In some embodiment, the gas environment of the grinding chamber can be kept inert by flowing an inert gas such as nitrogen through a gas inlet 203, which is also used to convey the milled particles out of the mill and into an air-classifier 208. The air-classifier 208 can separate the solid stream into a carbon-rich product stream 210 and a metal-contaminant-rich stream 209. Metal-rich contaminant streams may also be produced at the base of the mill, as the particles may be too heavy to fluidize. The milling may be done in continuously, semi-continuously, or batch.

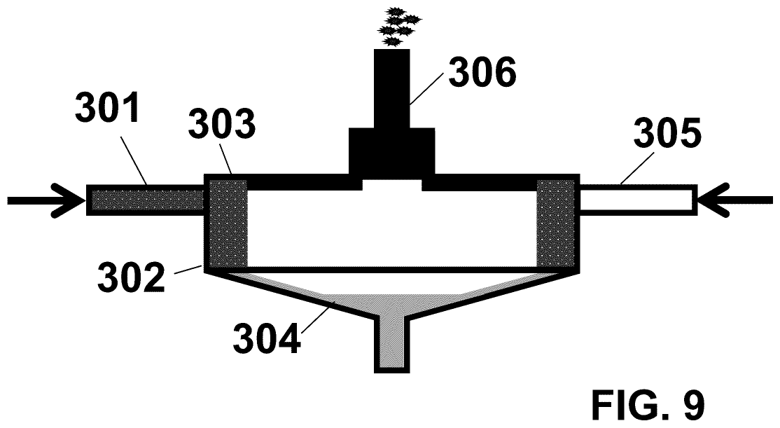

FIG. 9 shows another embodiment of the invention as applied to the grinding of solid carbon contaminated with a liquid-phase, metal contaminant. The contaminated solids stream 301 can be conveyed by gas to a jet mill 302. The jet mill can operate without grinding media as described herein. Rather, the particles can be conveyed within the jet mill 302 using high speed gasses to rotate and impact the particles into each other. The high-speed gases can be injected into the jet mill 302 through opening 305 in a tangential direction or at an angle sufficient to create circulation within the jet mill. Centrifugal forces can create a circulation of the contaminant particles within the jet mill to cause impacts and mechanical agitation of the contaminant particles. A central opening 306 in the center allows the gases to escape. When the product particles have a suitable size, the particles can migrate out of the jet mill 302 with the exiting gases. The resulting carbon rich particles can then be separated from the gas stream using a cyclone or settling chamber.

Macroscopic segregation of the two phases occurs in the high velocity gas stream 303 of the jet mill. The conditions within the jet mill can be maintained at or above the melting point of the liquid contaminants using a heater and/or by controlling the inlet temperature of the gasses used to operate the jet mill. In the preferred embodiment, the liquid-phase contaminant 304 is non-wetting to the solid product. The liquid phase products can then pass downwards in the jet mill 302. The liquid-phase contaminant collects at the bottom of the jet mill 302 where it may be drawn out by tapping, siphoning, etc. In the preferred embodiment, the gas environment of the jet mill can be kept inert by using nitrogen gas as the process gas opening 305. The use of a jet mill allows for most moving mechanical parts to be avoided. In some aspects, the jet mill 302 as described with respect to FIG. 9 may be used to further treat any of the streams processed using the mills as described with respect to FIGS. 4-8, though the jet mill 302 can also be used on its own.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

### Separation of Solid Carbon from a Mixture of Solid Carbon and a Solid Metal

In a specific example, 50 g of particulate carbon containing a dispersed, solid metallic tin contaminant phase is introduced to a 2 L ceramic milling jar containing 3 kg of spherical ceramic grinding media with diameters between 0.5 in and 1.0 in. The milling jar is rotated at 70 RPM for 10 minutes at room temperature in air, after which the contents of the jar are removed and dispersed in ethanol to form a suspension. The agglomerated particles of metallic tin segregate to the bottom of the container holding the suspension, and the carbon is extracted with the ethanol via siphoning into a separate vessel. The carbon particles are removed from the suspension by vacuum filtration.

### Example 2

### Separation of Solid Carbon from a Mixture of Solid Carbon and a Solid Metal

In a specific example, a carbon particulate stream contaminated with dispersed, solid metallic tin is delivered via screw auger to a rotary ball mill at a rate of between 0.5 and 100 kg/hr, as shown schematically in FIG. 20. The ball mill has an inner diameter of 24 in and is 96 in long, constructed of stainless steel, and rotates at 30 RPM. The grinding media consists of stainless steel balls with diameters of approximately 0.5 in to 1 in. The milled carbon along with the agglomerated and segregated metallic tin is conveyed out of the reactor via screw auger into an air classifier, which separates the carbon powder from the metallic contaminant.

### Example 3

In a specific example, 200 g of particulate carbon containing a dispersed, liquid metallic tin contaminant phase is introduced to a 5 L stainless steel milling jar containing 10 kg of spherical stainless steel grinding media with diameters between 0.5 in and 1.0 in. The milling jar is rotated at 60 RPM for 10 minutes at 250° C. in nitrogen, after which the contents of the jar are poured through a heated ceramic filter to separate the liquid tin contaminant from the solid carbon. The carbon powder is separated from the grinding media via sieving with stainless steel mesh.

### Example 4

### Continuous Separation of Solid Carbon from a Mixture of Solid Carbon and a Solid Metal in a Liquid Medium

In a specific example, a stream containing a carbon particulate contaminated with dispersed, solid metallic tin suspended in liquid hexane is delivered to a rotary ball mill at a rate of between 0.5 and 100 kg/hr and a percentage solids of between 5 and 50 weight percent, as shown schematically in FIG. 22. The ball mill has an inner diameter of 24 in and is 96 in long, constructed of stainless steel, and rotates at 30 RPM. The grinding media consists of stainless steel balls with diameters of approximately 0.5 in to 1 in. The milled carbon along with the agglomerated and segregated metallic tin is conveyed out of the reactor by the liquid hexane and into a sump tank. A slurry pump is then used to feed the process stream into a hydro-cyclone, which separates the carbon powder from the metallic contaminant.

### Example 5

### Continuous Separation of Solid Carbon from a Mixture of Solid Carbon and a Liquid Metal Using Autogenous Milling

In a specific example, a carbon particulate stream contaminated with dispersed, liquid metallic tin is delivered via gas conveyance to a jet mill at a rate of between 0.5 and 100 kg/hr, as shown schematically in FIG. 24. The jet mill has an inner diameter of 30 cm and has an additional 400 SCMH of nitrogen being tangentially injected into the mill. The milled carbon is conveyed out of the overflow of the jet mill. The liquid tin is conveyed out of the underflow of the jet mill.

Having described various reactors, systems, and methods, certain aspects as disclosed herein can include, but are not limited to:

In a first aspects, a process for purifying a solid comprising a contaminant adhered to a surface of the solid comprises passing the solid through a mechanical agitator; agitating the solid comprising the contaminant adhered to the surface of the solid in the mechanical agitator; removing at least a portion of the contaminant from the surface of the solid based on the agitating to form a purified solid; and removing the purified solid from the mechanical agitator.

A second aspect can include the process of the first aspect, wherein the solid comprises carbon.

A third aspect can include the process of the first or second aspect, wherein the contaminant comprises a metal.

A fourth aspect can include the process of the third aspect, wherein the metal comprises nickel, bismuth, copper, platinum, indium, lead, gallium, iron, palladium, tin, cobalt, tellurium, ruthenium, antimony, gallium, magnesium, calcium, sodium, potassium, any oxides thereof, or any combination thereof.

A fifth aspect can include the process of any one of the first to fourth aspects, wherein the agitating is performed under a non-oxidizing atmosphere.

A sixth aspect can include the process of any one of the first to fifth aspects, further comprising: heating the solid during the agitating.

A seventh aspect can include the process of any one of the first to sixth aspects, wherein the agitating is performed below a melting point of the contaminant.

An eighth aspect can include the process of any one of the first to seventh aspects, further comprising: agglomerating the portion of the contaminant removed from the surface of the solid.

A ninth aspect can include the process of any one of the first to eighth aspects, further comprising: removing the contaminant with the purified solid from the mechanical agitator; and separating the purified solid from the contaminant after removing the contaminant and purified solid from the mechanical agitator.

A tenth aspect can include the process of any one of the first to eighth aspects, further comprising: removing the portion of the contaminant removed from the solid as a first stream from the mechanical agitator; and removing the purified solid as a second stream from the mechanical agitator.

An eleventh aspect can include the process of any one of the first to ninth aspects, wherein the solid is disposed in a liquid when the solid is passed to the mechanical agitator and during the agitating.

A twelfth aspect can include the process of the eleventh aspect, wherein the mechanical agitator comprises a grinding media, and wherein a surface of the grinding media is non-wetting with respect to the liquid.

A thirteenth aspect can include the process of any one of the first to twelfth aspects, wherein the mechanical agitator comprises a rotary ball mill or a vertical stirred ball mill.

A fourteenth aspect can include the process of any one of the first to tenth aspects, wherein the mechanical agitator comprises a jet mill.

In a fifteenth aspect, a process for producing and purifying carbon comprising a contaminant adhered to a surface of the carbon comprises: contacting a hydrocarbon gas with a molten metal in a pyrolysis reactor; forming the carbon in response to the contacting, wherein the carbon comprises the contaminant adhered to the surface of the carbon; passing the carbon through a mechanical agitator; agitating the carbon comprising the contaminant adhered to the surface of the carbon in the mechanical agitator; removing at least a portion of the contaminant from the surface of the carbon based on the agitating to form a purified carbon; and removing the purified carbon from the mechanical agitator.

A sixteenth aspect can include the process of the fifteenth aspect, wherein the pyrolysis reactor comprises a bubble column reactor.

A seventeenth aspect can include the process of the fifteenth or sixteenth aspect, wherein the contaminant comprises a metal of the molten metal.

An eighteenth aspect can include the process of the seventeenth aspect, wherein the metal comprises nickel, bismuth, copper, platinum, indium, lead, gallium, iron, palladium, tin, cobalt, tellurium, ruthenium, antimony, gallium, magnesium, calcium, sodium, potassium, any oxides thereof, or any combination thereof.

A nineteenth aspect can include the process of any one of the fifteenth to eighteenth aspects, wherein the agitating is performed under an inert atmosphere.

A twentieth aspect can include the process of any one of the fifteenth to nineteenth aspects, further comprising: heating the carbon during the agitating.

A twenty first aspect can include the process of any one of the fifteenth to twentieth aspects, wherein the agitating is performed below a melting point of the contaminant.

A twenty second aspect can include the process of any one of the fifteenth to twenty first aspects, further comprising: agglomerating the portion of the contaminant removed from the surface of the carbon.

A twenty third aspect can include the process of any one of the fifteenth to twenty second aspects, further comprising: removing the contaminant with the purified carbon from the mechanical agitator; and separating the purified carbon from the contaminant after removing the contaminant and purified carbon from the mechanical agitator.

A twenty fourth aspect can include the process of any one of the fifteenth to twenty second aspects, further comprising: removing the portion of the contaminant removed from the carbon as a first stream from the mechanical agitator; and removing the purified carbon as a second stream from the mechanical agitator.

A twenty fifth aspect can include the process of any one of the fifteenth to twenty fourth aspects, wherein the carbon is disposed in a liquid when the carbon is passed to the mechanical agitator and during the agitating.

A twenty sixth aspect can include the process of the twenty fifth aspect, wherein the mechanical agitator comprises a grinding media, and wherein a surface of the grinding media is non-wetting with respect to the liquid.

A twenty seventh aspect can include the process of any one of the fifteenth to twenty sixth aspects, wherein the mechanical agitator comprises a rotary ball mill or a vertical stirred ball mill.

A twenty eighth aspect can include the process of any one of the fifteenth to twenty fourth aspects, wherein the mechanical agitator comprises a jet mill.

A twenty ninth aspect can include the process of any one of the fifteenth to twenty eighth aspects, further comprising: returning the portion of the contaminant to the pyrolysis reactor.

In a thirtieth aspect, a reactor system comprises: a pyrolysis reactor configured to receive a hydrocarbon gas and generate carbon as a product; the carbon, wherein the carbon comprises a contaminant adhered to a surface of the carbon; a mechanical agitator configured to receive the carbon comprising the contaminant and remove at least a portion of the contaminant from the surface of the carbon to generate a purified carbon; and the portion of the contaminant removed from the surface of the carbon.

A thirty first aspect can include the system of the thirtieth aspect, wherein the pyrolysis reactor comprises a bubble column reactor.

A thirty second aspect can include the system of the thirtieth or thirty first aspect, wherein the contaminant comprises a metal of the molten metal.

A thirty third aspect can include the system of the thirty second aspect, wherein the metal comprises nickel, bismuth, copper, platinum, indium, lead, gallium, iron, palladium, tin, cobalt, tellurium, ruthenium, antimony, gallium, magnesium, calcium, sodium, potassium, any oxides thereof, or any combination thereof.

A thirty fourth aspect can include the system of any one of the thirtieth to thirty third aspects, further comprising: a grinding media disposed within the mechanical agitator.

A thirty fifth aspect can include the system of the thirty fourth aspect, wherein the grinding media comprises metallic or ceramic spheres, rods, ellipsoids, or a combination thereof.

A thirty sixth aspect can include the system of any one of the thirtieth to thirty fifth aspects, further comprising: a liquid, wherein the carbon is mixed with the liquid within the mechanical agitator.

A thirty seventh aspect can include the system of the thirty sixth aspect, wherein a surface of the grinding media is non-wetting with respect to the liquid.

A thirty eighth aspect can include the system of any one of the thirtieth to thirty seventh aspects, further comprising: a screen disposed within the mechanical agitator, wherein the screen is configured to retain the purified carbon and allow the portion of the contaminant removed from the surface of the carbon to pass through.

A thirty ninth aspect can include the system of any one of the thirtieth to thirty eighth aspects, wherein the mechanical agitator is configured to: removing the portion of the contaminant removed from the carbon as a first stream from the mechanical agitator; and removing the purified carbon as a second stream from the mechanical agitator.

A fortieth aspect can include the system of any one of the thirtieth to thirty eighth aspects, further comprising: a separator configured to receive the contaminant with the purified carbon from the mechanical agitator, and separate at least a portion of the contaminant from the purified carbon.

A forty first aspect can include the system of any one of the thirtieth to fortieth aspects, wherein the mechanical agitator comprises a rotary ball mill or a vertical stirred ball mill.

A forty second aspect can include the system of any one of the thirtieth to fortieth aspects, wherein the mechanical agitator comprises a jet mill.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. A process for purifying a solid comprising a contaminant adhered to a surface of the solid, the process comprising:
passing the solid through a mechanical agitator;
agitating the solid comprising the contaminant adhered to the surface of the solid in the mechanical agitator;
removing at least a portion of the contaminant from the surface of the solid based on the agitating to form a purified solid; and
removing the purified solid from the mechanical agitator.

2. The process of claim 1, wherein the solid comprises carbon, and wherein the contaminant comprises a metal.

3. (canceled)

4. The process of claim 2, wherein the metal comprises nickel, bismuth, copper, platinum, indium, lead, gallium, iron, palladium, tin, cobalt, tellurium, ruthenium, antimony, gallium, magnesium, calcium, sodium, potassium, any oxides thereof, or any combination thereof.

5. (canceled)

6. The process of claim 1, further comprising:
heating the solid during the agitating, wherein the agitating is performed below a melting point of the contaminant.

7.-9. (canceled)

10. The process of claim 1, further comprising:
removing the portion of the contaminant removed from the solid as a first stream from the mechanical agitator; and
removing the purified solid as a second stream from the mechanical agitator.

11. The process of claim 1, wherein the solid is disposed in a liquid when the solid is passed to the mechanical agitator and during the agitating.

12. The process of claim 11, wherein the mechanical agitator comprises a grinding media, and wherein a surface of the grinding media is non-wetting with respect to the liquid.

13. The process of claim 1, wherein the mechanical agitator comprises a rotary ball mill, a vertical stirred ball mill, or a jet mill.

14. (canceled)

15. A process for producing and purifying carbon comprising a contaminant adhered to a surface of the carbon, the process comprising:
contacting a hydrocarbon gas with a molten metal in a pyrolysis reactor;
forming the carbon in response to the contacting, wherein the carbon comprises the contaminant adhered to the surface of the carbon;
passing the carbon through a mechanical agitator;
agitating the carbon comprising the contaminant adhered to the surface of the carbon in the mechanical agitator;
removing at least a portion of the contaminant from the surface of the carbon based on the agitating to form a purified carbon; and
removing the purified carbon from the mechanical agitator.

16. The process of claim 15, wherein the pyrolysis reactor comprises a bubble column reactor, and wherein the contaminant comprises a metal of the molten metal.

17. (canceled)

18. The process of claim 16, wherein the metal comprises nickel, bismuth, copper, platinum, indium, lead, gallium, iron, palladium, tin, cobalt, tellurium, ruthenium, antimony, gallium, magnesium, calcium, sodium, potassium, any oxides thereof, or any combination thereof.

19.-24. (canceled)

25. The process of claim 15, wherein the carbon is disposed in a liquid when the carbon is passed to the mechanical agitator and during the agitating, wherein the mechanical agitator comprises a grinding media, and wherein a surface of the grinding media is non-wetting with respect to the liquid.

26.-28. (canceled)

29. The process of claim 15, further comprising:
returning the portion of the contaminant to the pyrolysis reactor.

30. A reactor system comprising:
a pyrolysis reactor configured to receive a hydrocarbon gas and generate carbon as a product;
the carbon, wherein the carbon comprises a contaminant adhered to a surface of the carbon;
a mechanical agitator configured to receive the carbon comprising the contaminant and remove at least a portion of the contaminant from the surface of the carbon to generate a purified carbon; and
the portion of the contaminant removed from the surface of the carbon.

31. The system of claim 30, wherein the pyrolysis reactor comprises a bubble column reactor, and wherein the contaminant comprises a metal of the molten metal.

32. (canceled)

33. The system of claim 32, wherein the metal comprises nickel, bismuth, copper, platinum, indium, lead, gallium, iron, palladium, tin, cobalt, tellurium, ruthenium, antimony, gallium, magnesium, calcium, sodium, potassium, any oxides thereof, or any combination thereof.

34. The system of claim 30, further comprising:
a grinding media disposed within the mechanical agitator, wherein the grinding media comprises metallic or ceramic spheres, rods, ellipsoids, or a combination thereof.

35. (canceled)

36. The system of claim 30, further comprising:
a liquid, wherein the carbon is mixed with the liquid within the mechanical agitator.

37.-38. (canceled)

39. The system of claim 30, wherein the mechanical agitator is configured to:
removing the portion of the contaminant removed from the carbon as a first stream from the mechanical agitator; and
removing the purified carbon as a second stream from the mechanical agitator.

40. (canceled)

41. The system of claim 30, wherein the mechanical agitator comprises a rotary ball mill, a vertical stirred ball mill, or a jet mill.

42. (canceled)
